(19) United States
(12) Patent Application Publication
(10) Pub. No.: US 2025/0036978 A1
(43) Pub. Date: Jan. 30, 2025

(54) MODEL FINE-TUNING METHOD AND APPARATUS, AND DEVICE

(71) Applicant: VIVO MOBILE COMMUNICATION CO., LTD., Dongguan (CN)

(72) Inventors: Bule SUN, Dongguan (CN); Ang YANG, Dongguan (CN); Peng SUN, Dongguan (CN)

(73) Assignee: VIVO MOBILE COMMUNICATION CO., LTD., Dongguan (CN)

(21) Appl. No.: 18/914,254

(22) Filed: Oct. 13, 2024

Related U.S. Application Data
(63) Continuation of application No. PCT/CN2023/088228, filed on Apr. 13, 2023.

(30) Foreign Application Priority Data
Apr. 15, 2022 (CN) 202210395900.5

(51) Int. Cl. G06N 5/04

(52) U.S. Cl. CPC G06N 5/04

(57) ABSTRACT

This application discloses a model fine-tuning method and apparatus, and a device. The model fine-tuning method includes: obtaining, by a first device, first target information; fine-tuning, by the first device, the first Artificial Intelligence (AI) model based on the first information or the second information. The first target information includes first information and/or second information, the first information at least includes fine-tuning configuration-related information of a first AI model, and the second information at least includes fine-tuning mode information of the first AI model.

### CROSS-REFERENCE TO RELATED APPLICATIONS

This application is a continuation of International Application No. PCT/CN2023/088228, filed on Apr. 13, 2023, which claims priority to Chinese Patent Application No. 202210395900.5, filed on Apr. 15, 2022. The entire contents of each of the above-referenced applications are expressly incorporated herein by reference.

### TECHNICAL FIELD

This application pertains to the field of communication technologies, and in particular, to a model fine-tuning method and apparatus, and a device.

### BACKGROUND

With the rapid development of Artificial Intelligence (AI), the AI has been widely applied to various fields. For example, for the communication field, an AI module (such as an AI model) may be deployed on a terminal side or a network side to predict beam information and the like.

Currently, in a related art, a terminal or a network side device may usually perform model training in a transfer learning manner. However, in the transfer learning process, problems such as a poor model training effect still exist, which affects communication performance.

### SUMMARY

Embodiments of this application provide a model fine-tuning method and apparatus, and a device, which can improve a model training effect to ensure communication performance.

According to a first aspect, a model fine-tuning method is provided, and the method includes: A first device obtains first target information. The first target information includes at least one of first information and/or second information, the first information at least includes fine-tuning configuration-related information of a first AI model, and the second information at least includes fine-tuning mode information of the first AI model. The first device fine-tunes the first AI model based on the first information and/or the second information.

According to a second aspect, a model fine-tuning method is provided, including: A second device sends first target information to a first device. The first target information includes first information and/or second information, the first information at least includes fine-tuning configuration-related information of a first AI model, and the second information at least includes fine-tuning mode information of the first AI model.

According to a third aspect, a model fine-tuning apparatus is provided. The apparatus is used in a first device, and includes: a first obtaining module, configured to obtain first target information, where the first target information includes first information and/or second information, the first information at least includes fine-tuning configuration-related information of a first AI model, and the second information at least includes fine-tuning mode information of the first AI model; and a fine-tuning module, configured to fine-tune the first AI model based on the first information and/or the second information.

According to a fourth aspect, a model fine-tuning apparatus is provided, including: a second sending module, configured to send first target information to a first device. The first target information includes first information and/or second information, the first information at least includes fine-tuning configuration-related information of a first AI model, and the second information at least includes fine-tuning mode information of the first AI model.

According to a fifth aspect, a device is provided. The device includes: a processor, a memory, and a program or an instruction that is stored in the memory and capable of running on the processor. When the program or the instruction is executed by the processor, the steps of the method according to the first aspect are implemented or the steps of the method according to the second aspect are implemented.

According to a sixth aspect, a terminal is provided, including a processor and a communication interface. The communication interface is coupled to the processor, and the processor is configured to run a program or an instruction, to implement the steps of the method according to the first aspect or to implement the steps of the method according to the second aspect.

According to a seventh aspect, a model fine-tuning system is provided, including a first device and a second device. The first device is configured to perform the steps of the model fine-tuning method according to the first aspect, and the second device is configured to perform the steps of the model fine-tuning method according to the second aspect.

According to an eighth aspect, a readable storage medium is provided. The readable storage medium stores a program or an instruction, and when the program or the instruction is executed by a processor, the steps of the method according to the first aspect are implemented or the steps of the method according to the second aspect are implemented.

According to a ninth aspect, a chip is provided. The chip includes a processor and a communication interface, the communication interface is coupled to the processor, and the processor is configured to run a program or an instruction, to implement the steps of the method according to the first aspect or to implement the steps of the method according to the second aspect.

According to a tenth aspect, a computer program product/program product is provided. The computer program product/program product is stored in a storage medium, and the computer program product/program product is executed by at least one processor, to implement the steps of the method according to the first aspect or to implement the steps of the method according to the second aspect.

In embodiments of this application, migration of the first target information (such as the fine-tuning configuration-related information of the first AI model and the fine-tuning mode information of the first AI model) enables the first device to perform training (or fine-tuning, verification, or the like) of the first AI model based on the first target information, so that an effect of training (or fine-tuning, verification, or the like) of the AI model on the first device can be improved, and communication performance can be ensured.

### BRIEF DESCRIPTION OF THE DRAWINGS

FIG. 1 is a schematic diagram of a structure of a wireless communication system according to an example embodiment of this application;

FIG. 2 is a schematic flowchart of a model fine-tuning method according to an example embodiment of this application;

FIG. 3 is a schematic flowchart of a model fine-tuning method according to another embodiment of this application;

FIG. 4 is a schematic flowchart of a model fine-tuning method according to still another embodiment of this application;

FIG. 5 is a schematic diagram of a structure of a model fine-tuning apparatus according to an example embodiment of this application;

FIG. 6 is a schematic diagram of a structure of a model fine-tuning apparatus according to another example embodiment of this application;

FIG. 7 is a schematic diagram of a structure of a device according to an example embodiment of this application;

FIG. 8 is a schematic diagram of a structure of a terminal according to an example embodiment of this application; and

FIG. 9 is a schematic diagram of a structure of a network side device according to an example embodiment of this application.

### DETAILED DESCRIPTION

The following clearly describes technical solutions in embodiments of this application with reference to accompanying drawings in embodiments of this application. Apparently, the described embodiments are some but not all of the embodiments of this application. All other embodiments obtained by a person of ordinary skill in the art based on embodiments of this application shall fall within the protection scope of this application.

The terms “first”, “second”, and the like in the specification and claims of this application are used to distinguish between similar objects instead of describing a specific order or sequence. It should be understood that, the terms used in such a way is interchangeable in proper circumstances, so that embodiments of this application can be implemented in an order other than the order illustrated or described herein. Objects classified by “first” and “second” are usually of a same type, and the number of objects is not limited. For example, there may be one or more first objects. In addition, “and/or” in the specification and claims represents at least one of connected objects, and the character “/” generally indicates that the associated objects have an “or” relationship.

It is worth noting that the technologies described in embodiments of this application are not limited to a Long Term Evolution (LTE)/LTE-Advanced (LTE-A) system, and are further applicable to another wireless communication system, such as Code Division Multiple Access (CDMA), Time Division Multiple Access (TDMA), Frequency Division Multiple Access (FDMA), Orthogonal Frequency Division Multiple Access (OFDMA), Single-carrier Frequency-Division Multiple Access (SC-FDMA), or another system. The terms “system” and “network” in embodiments of this application are often used interchangeably, the described technologies may be used in the above-mentioned systems and radio technologies as well as other systems and radio technologies. The following descriptions describe a New Radio (NR) system for example purposes, and NR terms are used in most of the following descriptions, but the technologies may also be applied to applications other than NR system applications, such as a communication system with a wireless AI function such as 5.5th Generation (5.5G) and 6th Generation (6G).

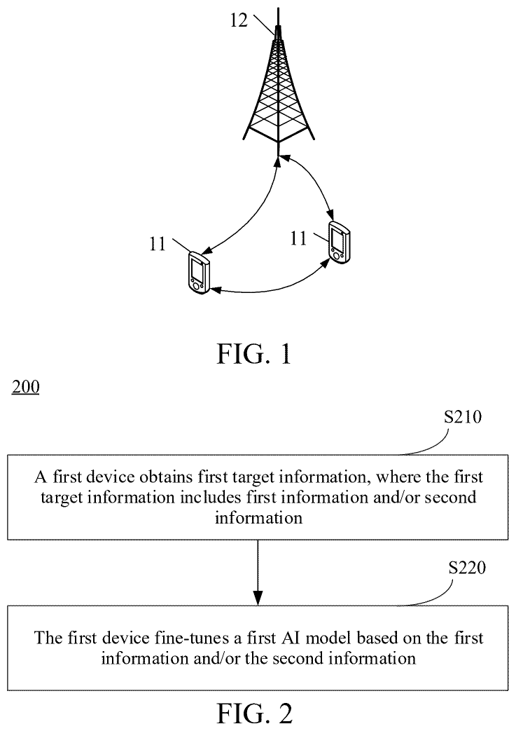

FIG. 1 is a block diagram of a wireless communication system to which embodiments of this application are applicable. The wireless communication system includes a terminal 11 and a network side device 12. The terminal 11 may be a terminal side device such as a mobile phone, a tablet personal computer, a laptop computer, or be referred to as a notebook computer, a Personal Digital Assistant (PDA), a palmtop computer, a netbook, an Ultra-Mobile Personal Computer (UMPC), a Mobile Internet Device (MID), an Augmented Reality (AR)/Virtual Reality (VR) device, a robot, a wearable device, Vehicle User Equipment (VUE), Pedestrian User Equipment (PUE), a smart home device (a home device with a wireless communication function, such as a refrigerator, a television, a washing machine, or furniture), a game machine, a Personal Computer (PC), a teller machine, or a self-service machine, and a wearable device includes: a smart watch, a smart band, a smart headset, smart glasses, smart jewelry (a smart bracelet, a smart hand chain, a smart ring, a smart necklace, a smart bangle, a smart anklet, and the like), a smart wrist strap, a smart dress, and the like. It should be noted that a specific type of the terminal 11 is not limited in embodiments of this application. The network side device 12 may include an access network device or a core network device. The access network device 12 may also be referred to as a radio access network device, a Radio Access Network (RAN), a radio access network function, or a radio access network unit. The access network device 12 may include a base station, a Wireless Local Area Network (WLAN) access point, a Wi-Fi node, or the like. The base station may be referred to as a NodeB, an evolved NodeB (CNB), an access point, a Base Transceiver Station (BTS), a radio base station, a radio transceiver, a Basic Service Set (BSS), an Extended Service Set (ESS), a home NodeB, a home evolved NodeB, a Transmission and Reception Point (TRP), or some other appropriate term in the art. As long as the same technical effect is achieved, the base station is not limited to a specific technology vocabulary. It should be noted that a base station in an NR system is merely used as an example for description in embodiments of this application, but the base station is not limited to a specific type. With reference to the accompanying drawings, the following describes in detail the technical solutions provided in embodiments of this application by using some embodiments and application scenarios thereof.

FIG. 2 is a schematic flowchart of a model fine-tuning method 200 according to an example embodiment of this application. The method 200 may be performed by, but is not limited to, a first device, and may be specifically performed by hardware and/or software installed in the first device. In this embodiment, the method 200 may at least include the following steps.

S210: The first device obtains first target information.

The first device may be a terminal or a network side device. Correspondingly, a second device mentioned subsequently in this application may also be a terminal or a network side device. This is not limited herein.

The first target information includes first information and/or second information. The first information at least includes fine-tuning configuration-related information of a first AI model, and is used for the first device to fine-tune the first AI model. The second information at least includes fine-tuning mode information of the first AI model, and is used for the first device to fine-tune the first AI model.

In other words, in this embodiment, for the first device, if the first device is configured with or obtains the first AI model but lacks a corresponding model training parameter, or the first device is not equipped with the first AI mode but needs to use the first AI mode, or the like, fine-tuning efficiency of the first AI model by the first device may be improved through migration of the first target information (for example, the fine-tuning configuration-related information of the first AI model or the fine-tuning mode information of the first AI model), thereby ensuring communication performance. It should be understood that, model “fine-tuning” mentioned in this application may also be understood as model training, model verification, and the like. This is not limited herein.

It is worth noting that, the first target information may be obtained in a plurality of manners. For example, the first target information may be sent by the second device, or may be configured by a higher layer or configured by a network side. Certainly, in an implementation, if the first target information is sent by the second device, when the second device sends the first target information, the first target information may be sent based on a target information request message sent by the first device, or the second device may autonomously determine whether to send and when to send the first target information, or the like. This is not limited herein. Correspondingly, if the first target information includes the first information and the second information, the first information and the second information may be sent independently, or may be sent one by one, or may be sent through a piece of signaling after being packaged. This is not limited herein.

In addition, when the second device sends the first target information (for example, the first information and the second information), the first target information may be transmitted through, but is not limited to, any one of the following: a Medium Access Control Control Element (MAC CE), a Radio Resource Control (RRC) message, a Non Access Stratum (NAS) message, a management orchestration message, user plane data (such as a logical channel or a Data Radio Bearer (DRB) or a protocol data unit session (Protocol Data Unit session, PDU session)), Downlink Control Information (DCI), a System Information Block (SIB), Physical Downlink Control Channel (PDCCH) layer 1 (Layer 1) signaling, Physical Downlink Shared Channel (PDSCH) information, a Physical Random Access Channel (PRACH) message (MSG) 2, a PRACH MSG 4, a PRACH MSG 5, Xn interface signaling, PC5 interface signaling, Physical SideLink Control Channel (PSCCH) information, Physical SideLink Shared Channel (PSSCH) information, Physical SideLink Broadcast Channel (PSBCH) information, Physical SideLink Discovery Channel (PSDCH) information, and Physical SideLink Feedback Channel (PSFCH) information.

S220: The first device fine-tunes the first AI model based on the first information and/or the second information.

The first AI model may be an AI model that the second device sends to the first device through the first target information (that is, the first target information may further include third information, and the third information at least includes information of the first AI model, such as model structure information, model parameter information, model identification information, and the like of the first AI model), or may be pre-configured in the first device. Certainly, it should be noted that, depending on different communication scenarios, the first AI model can be a neural network, a decision tree, a support vector machine, a Bayesian classifier, and the like. This is not limited herein.

In this embodiment, through migration of the first target information (such as the fine-tuning configuration-related information of the first AI model and the fine-tuning mode information of the first AI model), the first device can perform training (or fine-tuning, verification, or the like) of the first AI model based on the first target information. This can improve efficiency of training (or fine-tuning, verification, or the like) of the AI model on the first device and ensure communication performance, and avoid a problem of low AI model training efficiency.

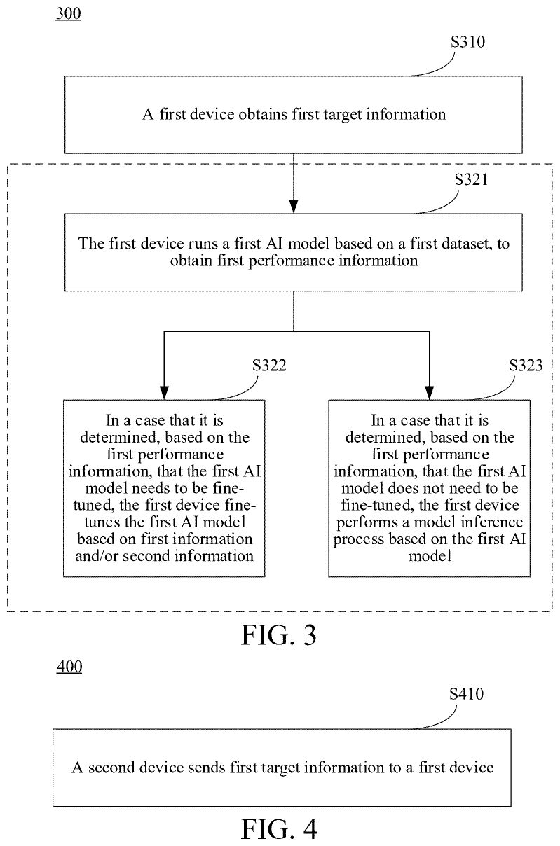

FIG. 3 is a schematic flowchart of a model fine-tuning method 300 according to an example embodiment of this application. The method 300 may be performed by, but is not limited to, a first device, and may be specifically performed by hardware and/or software installed in the first device. In this embodiment, the method 300 may at least include the following steps.

S310: The first device obtains first target information.

The first target information includes first information and/or second information, the first information at least includes fine-tuning configuration-related information of a first AI model, and the second information at least includes fine-tuning mode information of the first AI model.

It may be understood that, except that reference may be made to the related descriptions in the method embodiment 200 in an implementation process of S310, as a possible implementation, the first AI model may be any one of the following (11) to (14).

(11) A model preconfigured on a second device.

For example, the first AI model is a model that is preconfigured (or stored) on the second device through a protocol agreement, high-layer configuration, or the like. The second device is a device that sends the first target information to the first device. (12) A model preconfigured on the first device.

For example, the first AI model is a model that is preconfigured (or stored) on the first device through a protocol agreement, high-layer configuration, or the like. In some embodiments, the first AI model may be a model trained by the first device.

(13) A model trained by the second device, that is, the first AI model is a model trained by the second device.

(14) A model relayed by the second device. For example, a device other than the first device or the second device sends the first AI model to the second device, and then the second device relays the first AI model to the first device or another device, or the like.

In an implementation, considering that the fine-tuning configuration-related information of the first AI model is used for the first device to fine-tune the first AI model, in this embodiment, the fine-tuning configuration-related information of the first AI model may include, but is not limited to, at least one of the following (201) to (211).

(201) A quantity of first layers. The first layer is a layer that does not require parameter fine-tuning in the first AI model, that is, when the first device fine-tunes a neural network in the first AI model, a parameter of the first layer does not change, thereby improving model fine-tuning efficiency and avoiding an occurrence of an invalid fine-tuning action.

In this embodiment, the first layer may be different based on different first AI models, different application scenarios, and the like.

(202) A quantity of second layers. The second layer is a layer that requires parameter fine-tuning in the first AI model.

Corresponding to the foregoing first layer, the second layer may be understood as that a parameter of the second layer needs to be changed when the first device fine-tunes the neural network in the first AI model.

(203) An index (Index) of the first layer. The index of the first layer is used for the first device to determine the first layer. Based on this, the “index” may also be understood as indication information of the first layer, or the like.

(204) An index of the second layer, which is similar to the foregoing index of the first layer. To avoid repetition, details are not described herein again.

(205) A fine-tuning data volume. The fine-tuning data volume is a data volume of fine-tuning data required when the first AI model is fine-tuned.

(206) A target batch quantity. The target batch quantity is a batch quantity of fine-tuning data required when the first AI model is fine-tuned. For example, assuming that the target batch quantity is 5, and the fine-tuning data volume is 200, a dataset of each batch of data used when model fine-tuning is performed for one time may include 40 pieces of data.

(207) A batch size (batch or minibatch). The batch size is a size of a data volume of each batch of fine-tuning data required when the first AI model is fine-tuned. Assuming that the example in (206) is continued, in this example, the “batch size” may be “40”.

Certainly, it is worth noting that the “batch size” in (207) does not depend on the “target batch quantity” in (206) and/or the “fine-tuning data volume” in (205).

(208) A quantity of model iterations. The quantity of model iterations is a total quantity of iterations required to achieve when the first AI model is fine-tuned for one time. The quantity of model iterations may also be understood as a quantity of model updates or a quantity of epochs. This is not limited herein. An “epoch” refers to a process of sending all data into an AI model to complete one time of forward propagation and backward propagation, or an “epoch” refers to a process of using all fine-tuning data for one time of training.

When the quantity of model iterations is a plurality of times, different iterations may use different or the same fine-tuning datasets. This is not limited herein.

(209) Target performance. The target performance is model performance to be achieved when the first AI model is fine-tuned. The target performance may be a learning class performance indicator such as precision, an error, a mean square error, a normalized mean square error, or a similarity, or may be a task-oriented performance indicator, such as a throughput, a load, a bit error probability, a block error probability, a call drop rate, a miss witching probability, or the like. This is not limited herein.

(210) A fine-tuning learning rate (Learning rate). The fine-tuning learning rate is used as an important hyperparameter in supervised learning and deep learning, and determines whether and when an objective function corresponding to the first AI model can converge to a local minimum. An appropriate learning rate enables the objective function to converge to the local minimum within appropriate time.

(211) An adjustment strategy of fine-tuning rate. The fine-tuning learning change strategy may include, but is not limited to, fixed step decay (StepLR), multistep decay (MultiStepLR), exponential decay (ExponentialLR), cosine annealing decay (CosineAnnealingLR), learning rate warm up (warm up), and the like.

In another implementation, the fine-tuning mode information of the first AI model may include at least one of the following (31) to (35).

(31) A single fine-tuning mode.

Assuming that the fine-tuning mode information corresponding to the first AI model is the single fine-tuning mode, the first device may only perform fine-tuning on the first AI model for one time, and a time period of single fine-tuning and used fine-tuning data may be indicated by the second device or autonomously determined by the first device. This is not limited herein.

(32) A cyclic fine-tuning mode.

(33) A fine-tuning cycle corresponding to the cyclic fine-tuning mode.

Assuming that the fine-tuning mode information corresponding to the first AI model is the cyclic fine-tuning mode, the first device may perform model fine-tuning based on the fine-tuning cycle indicated in (33). However, if the fine-tuning mode information of the first AI model does not include the fine-tuning cycle, the first device may autonomously determine a fine-tuning cycle or the like, or the fine-tuning cycle may be implemented through a protocol agreement or the like. This is not limited herein.

(34) An event-triggered fine-tuning mode.

(35) Trigger event information corresponding to the event-triggered fine-tuning mode. Assuming that the fine-tuning mode information corresponding to the first AI model is the event-triggered fine-tuning mode, the first device may perform model fine-tuning based on the trigger event information indicated in (35). For example, when the trigger event occurs or is met, the first device performs model fine-tuning.

In some embodiments, the trigger event may be that the first device receives a predetermined instruction and predetermined signaling, or model performance of the first AI model is less than a predetermined threshold. The predetermined instruction and the predetermined signaling may be carried in a MAC CE, an RRC message, a NAS message, a management orchestration message, user plane data (such as a logical channel, or a DRB or a PDU session), DCI information, a SIB, or the like for transmission. This is not limited herein.

In some embodiments, the foregoing information of the first AI model, the fine-tuning configuration-related information of the first AI model, and the fine-tuning mode information of the first AI model include the foregoing content, which may be implemented through a protocol agreement, high-layer configuration, or network side configuration. This is not limited herein.

S320: The first device fine-tunes the first AI model based on the first information and/or the second information.

It may be understood that, except that reference may be made to the related descriptions in the method embodiment 200 in an implementation process of S320, as a possible implementation, a process in which the first device fine-tunes the first AI model based on the first information and/or the second information may include S321 to S323 shown in FIG. 3. The content is as follows.

S321: The first device runs the first AI model based on a first dataset, to obtain first performance information.

The first AI model may be determined by the first device based on information of the first AI model included in third information. The first dataset may be a dataset that the first device collects and that has been stored for a period of time, or may be a dataset that the first device collects online and that dynamically changes. In other words, as new data arrives, old data is deleted from the first dataset.

In an implementation, after running the first AI model based on the first dataset, the first device can obtain a first model output result, determine the first performance information based on the first model output result, and then determine whether the first AI model needs to be fine-tuned based on the first performance information.

Based on this, as a possible implementation, the first device may determine that the first AI model needs to be fine-tuned in a case that the first performance information meets a first condition. The first performance information may be a learning class performance indicator such as precision, an error, a mean square error, a normalized mean square error, or a similarity, or may be a task-oriented performance indicator, such as a throughput, a load, a bit error probability, a block error probability, a call drop rate, a miss witching probability, or the like. This is not limited herein.

Based on this, in this embodiment, the first condition may include, but is not limited to, at least one of the following (41) to (46).

(41) The first performance information is greater than or equal to a first threshold.

The first threshold is different based on different first performance information.

(42) The first performance information is less than or equal to a second threshold.

(43) Within a first time period, a quantity of times that the first performance information is greater than or equal to the first threshold reaches a third threshold.

(44) Within a second time period, a quantity of times that the first performance information is less than or equal to the second threshold reaches a fourth threshold.

(45) A duration during which the first performance information is greater than or equal to the first threshold reaches a fifth threshold.

(46) A duration during which the first performance information is less than or equal to the second threshold reaches a sixth threshold.

It is worth noting that, sizes of the first threshold, the second threshold, the third threshold, the fourth threshold, the fifth threshold, the sixth threshold, the first time period, and the second time period may be implemented through a protocol agreement, high-layer configuration, or network side configuration. Certainly, the first threshold and the second threshold may be the same or different, the third threshold and the fourth threshold may be the same or different, the fifth threshold and the sixth threshold may be the same or different, and the first time period and the second time period may be the same or different. This is not limited herein.

S322: In a case that it is determined, based on the first performance information, that the first AI model needs to be fine-tuned, the first device fine-tunes the first AI model based on the first information and/or the second information.

In an implementation, the step that the first device fine-tunes the first AI model based on the first information and/or the second information may include fine-tuning the first AI model based on at least one of a second dataset, the first information, and the second information. Certainly, it may be understood that, the fact that the first device performs model fine-tuning based on which of the second data set, the first information, and the second information may be implemented through protocol agreement, high-layer configuration, or network side configuration. This is not limited herein.

For example, the first device may fine-tune the first AI model based on both the second dataset and the first information, or may fine-tune the first AI model based on only the second dataset or the first information or the second information, or the like. This is not limited herein.

In addition, the second dataset may be the same as or different from the foregoing first dataset. This is not limited herein.

It is worth noting that, when the first device determines to fine-tune the first AI model based on at least one of the second dataset, the first information and the second information, if the first target information does not include the first information, the first device may send a first request to the second device. The first request is used to request the first information from the second device. Correspondingly, in a case of receiving the first request, the first device may send the first information to the second device, so that the first device fine-tunes the first AI model.

S323: In a case that it is determined, based on the first performance information, that the first AI model does not need to be fine-tuned, the first device performs a model inference process based on the first AI model.

The model inference process may be that the first device uses the first AI model to predict beam information, infer and determine channel state information (Channel State Information, CSI) reporting, predict a communication channel state, or the like. This is not limited herein.

Certainly, as a possible implementation, in the model inference process, or after the first AI model is fine-tuned for one or more times, the first device determines that the AI model needs to be fine-tuned again. For example, model performance information of a second AI model meets a second condition or meets a fine-tuning cycle, or a trigger event occurs. In this case, the first device may again fine-tune the second AI model based on at least one of a third dataset, the first information, and the second information.

The second condition is determined based on at least one piece of information other than the single fine-tuning mode in the fine-tuning mode information of the first AI model. For example, the second condition may be “a fine-tuning trigger event occurring” determined based on the event-triggered fine-tuning mode, or “a fine-tuning cycle reaching” determined based on the cyclic fine-tuning mode. Certainly, in an implementation, the second condition may be that model performance of the second AI model meets the foregoing first condition or the like. This embodiment is not limited herein.

It is worth noting that, the second AI model is a model obtained after model fine-tuning is performed on the first AI model for at least one time, or the second AI model is the first AI model that is in a model inference process or has completed at least one model inference process.

In this case, to ensure consistency of understanding of the first AI model by the first device, the second device, and a third device, or implement maintenance, global monitoring, and the like of the first AI model, after fine-tuning the first AI model or performing a model inference process by using the first AI model, the first device may feed back model performance information and the like to the second device and/or the third device, that is, the first device may send second target information to the second device or the third device. The second device is a device that sends the first target information to the first device, the third device is a monitoring or maintenance device of the first AI model, and the second target information includes at least one of the following (51) to (54).

(51) The first performance information. The first performance information is the model performance information of the first AI model.

(52) Second performance information. The second performance information is the model performance information of the second AI model.

The second performance information is similar to the foregoing first performance information. The second performance information may be a learning class performance indicator such as precision, an error, a mean square error, a normalized mean square error, or a similarity, or may be a task-oriented performance indicator, such as a throughput, a load, a bit error probability, a block error probability, a call drop rate, a miss witching probability, or the like. This is not limited herein.

(53) First indication information. The first indication information is used to indicate that the first device has completed fine-tuning the second AI model.

(54) Second indication information. The second indication information is used to indicate that the first device has performed a model inference process based on the second AI model.

The first indication information and the second indication information may be implicit indication information or explicit indication information. This is not limited herein.

It is worth noting that, when the first device sends (or feeds back) the second target information, the first device may feed back before model fine-tuning starts or before an inference process starts, or may feed back after the model fine-tuning is completed or after the model inference process is completed. This is not limited herein.

In addition, for example, similar to sending of the foregoing first target information, the second target information may be transmitted through, but is not limited to, any one of a MAC CE, an RRC, a NAS message, a management orchestration message, user plane data (such as a logical channel, or a DRB or a PDU session), a DCI, a SIB, PDCCH Layer 1 signaling, PDSCH information, a PRACH MSG 2, a PRACH MSG 4, a PRACH MSG B, Xn interface signaling, PC5 interface signaling, PSCCH information, PSSCH information, PSBCH information, PSDCH information, and PSFCH information.

In this embodiment, when transfer learning using another device (for example, the second device) in a communication system, relevant configuration information (for example, the first target information) required for fine-tuning needs to be sent to the first device, to assist the first device in better implementing fine-tuning and training of an AI model, improve model training efficiency, and ensure performance of the communication system.

FIG. 4 is a schematic flowchart of a model fine-tuning method 400 according to an example embodiment of this application. For example, the method 400 may be performed by, but is not limited to, a second device, and may be performed by hardware and/or software installed in the second device. In this embodiment, the method 400 may at least include the following steps.

S410: The second device sends first target information to a first device.

The first target information includes first information and/or second information, the first information at least includes fine-tuning configuration-related information of a first AI model, and the second information at least includes fine-tuning mode information of the first AI model.

In some embodiments, the first target information is sent by the second device, and the first AI model is any one of the following: a model preconfigured on the first device; a model preconfigured on the second device; a model trained by the second device; and a model relayed by the second device. The second device is a device that sends the first target information to the first device.

In some embodiments, the fine-tuning configuration-related information of the first AI model includes at least one of the following: a quantity of first layers, where the first layer is a layer that does not require parameter fine-tuning in the first AI model; a quantity of second layers, where the second layer is a layer that requires parameter fine-tuning in the first AI model; an index of the first layer; an index of the second layer; a fine-tuning data volume, where the fine-tuning data volume is a data volume required when the first AI model is fine-tuned; a target batch quantity, where the target batch quantity is a batch quantity of fine-tuning data required when the first AI model is fine-tuned; a batch size, where the batch size is a size of a data volume of each batch of fine-tuning data required when the first AI model is fine-tuned; a quantity of model iterations, where the quantity of model iterations is a total quantity of iterations required to achieve when the first AI model is fine-tuned for one time; target performance, where the target performance is model performance to be achieved when the first AI model is fine-tuned; a fine-tuning learning rate; and an adjustment strategy of fine-tuning rate.

In some embodiments, the fine-tuning mode information of the first AI model includes at least one of the following: a single fine-tuning mode; a cyclic fine-tuning mode; a fine-tuning cycle corresponding to the cyclic fine-tuning mode; an event-triggered fine-tuning mode; and trigger event information corresponding to the event-triggered fine-tuning mode.

In some embodiments, the method further includes: The second device receives a first request sent by the first device. The second device sends the first information to the first device based on the first request.

In some embodiments, the method further includes: The second device receives second target information sent by the first device. The second target information includes at least one of the following: first performance information, where the first performance information is model performance information of the first AI model; second performance information, where the second performance information is model performance information of a second AI model; first indication information, where the first indication information is used to indicate that the first device has completed fine-tuning the second AI model; and second indication information, where the second indication information is used to indicate that the first device has performed a model inference process based on the second AI model. The second AI model is a model obtained after model fine-tuning is performed on the first AI model for at least one time, or the second AI model is the first AI model that is in a model inference process or has completed at least one model inference process.

It may be understood that, because the implementations mentioned in the method embodiment 400 have the same or corresponding technical features as the foregoing implementations in the method embodiments 200 and/or 300, for implementation processes of the implementations in the method embodiment 400, reference may be made to the related descriptions in the method embodiments 200 and/or 300, with the same or corresponding technical effect achieved. To avoid repetition, details are not described herein again.

The model fine-tuning methods 200 to 400 provided in embodiments of this application may be performed by a model fine-tuning apparatus. In embodiments of this application, the model fine-tuning methods 200 to 400 performing by model fine-tuning apparatus is used as an example to describe the model fine-tuning apparatus provided in embodiments of this application.

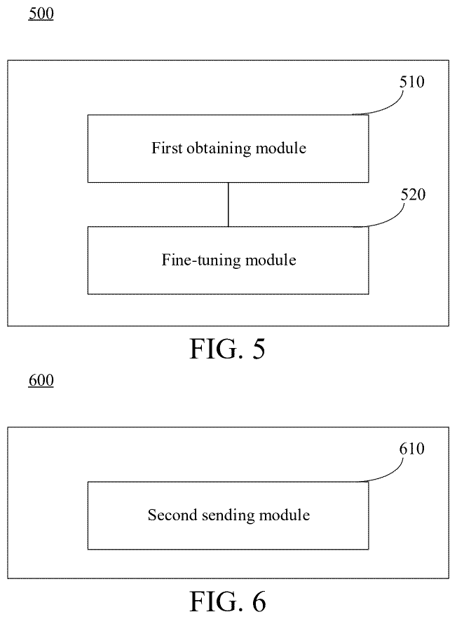

FIG. 5 is a schematic diagram of a structure of a model fine-tuning apparatus 500 according to an example embodiment of this application. The apparatus 500 includes: a first obtaining module 510, configured to obtain first target information, where the first target information includes first information and/or second information, the first information at least includes fine-tuning configuration-related information of a first AI model, and the second information at least includes fine-tuning mode information of the first AI model; and a fine-tuning module 520, configured to fine-tune the first AI model based on the first information and/or the second information.

In some embodiments, the first target information is sent by a second device, and the first AI model is any one of the following: a model preconfigured on a first device; a model preconfigured on the second device; a model trained by the second device; and a model relayed by the second device. The second device is a device that sends the first target information to the first device.

In some embodiments, the first target information further includes third information, and the third information at least includes information of the first AI model.

In some embodiments, the fine-tuning configuration-related information of the first AI model includes at least one of the following: a quantity of first layers, where the first layer is a layer that does not require parameter fine-tuning in the first AI model; a quantity of second layers, where the second layer is a layer that requires parameter fine-tuning in the first AI model; an index of the first layer; an index of the second layer; a fine-tuning data volume, where the fine-tuning data volume is a data volume required when the first AI model is fine-tuned; a target batch quantity, where the target batch quantity is a batch quantity of fine-tuning data required when the first AI model is fine-tuned; a batch size, where the batch size is a size of a data volume of each batch of fine-tuning data required when the first AI model is fine-tuned; a quantity of model iterations, where the quantity of model iterations is a total quantity of iterations required to achieve when the first AI model is fine-tuned for one time; target performance, where the target performance is model performance to be achieved when the first AI model is fine-tuned; a fine-tuning learning rate; and an adjustment strategy of fine-tuning rate.

In some embodiments, the fine-tuning mode information of the first AI model includes at least one of the following: a single fine-tuning mode; a cyclic fine-tuning mode; a fine-tuning cycle corresponding to the cyclic fine-tuning mode; an event-triggered fine-tuning mode; and trigger event information corresponding to the event-triggered fine-tuning mode.

In some embodiments, the fine-tuning module 520 is further configured to: run the first AI model based on a first dataset, to obtain first performance information; and in a case that it is determined, based on the first performance information, that the first AI model needs to be fine-tuned, perform a step of fine-tuning the first AI model based on the first information and/or the second information.

In some embodiments, in a case that it is determined, based on the first performance information, that the first AI model does not need to be fine-tuned, the fine-tuning module 520 is further configured to perform a model inference process based on the first AI model.

In some embodiments, that the fine-tuning module 520 determines, based on the first performance information, that the first AI model needs to be fine-tuned includes: in a case that the first performance information meets a first condition, determining that the first AI model needs to be fine-tuned. The first condition includes at least one of the following: the first performance information is greater than or equal to a first threshold; the first performance information is less than or equal to a second threshold; within a first time period, a quantity of times that the first performance information is greater than or equal to the first threshold reaches a third threshold; within a second time period, a quantity of times that the first performance information is less than or equal to the second threshold reaches a fourth threshold; a duration during which the first performance information is greater than or equal to the first threshold reaches a fifth threshold; and a duration during which the first performance information is less than or equal to the second threshold reaches a sixth threshold.

In some embodiments, the apparatus 500 further includes: a first sending module, configured to: in a case that the first target information does not include the first information, the first device sends a first request to the second device, where the first request is used to request the first information from the second device. The first obtaining module 510 is further configured to receive the first information sent by the second device.

In some embodiments, the apparatus 500 further includes: in a case that model performance information of a second AI model meets a second condition, the fine-tuning module 520 is further configured to fine-tune the second AI model based on at least one of a third dataset, the first information, and the second information. The second condition is determined based on at least one piece of information other than the single fine-tuning mode in the fine-tuning mode information of the first AI model, and the second AI model is a model obtained after model fine-tuning is performed on the first AI model for at least one time, or the second AI model is the first AI model that is in a model inference process or has completed at least one model inference process.

In some embodiments, the first sending module is further configured to send second target information to the second device or a third device. The third device is a monitoring or maintenance device of the first AI model, the second device is a device that sends the first target information to the first device, and the second target information includes at least one of the following: the first performance information, where the first performance information is model performance information of the first AI model; second performance information, where the second performance information is the model performance information of the second AI model; first indication information, where the first indication information is used to indicate that the first device has completed fine-tuning the second AI model; and second indication information, where the second indication information is used to indicate that the first device has performed a model inference process based on the second AI model, wherein The second AI model is a model obtained after model fine-tuning is performed on the first AI model for at least one time, or the second AI model is the first AI model that is in a model inference process or has completed at least one model inference process.

FIG. 6 is a schematic diagram of a structure of a model fine-tuning apparatus 600 according to an example embodiment of this application. The apparatus 600 includes: a second sending module 610, configured to send first target information to a first device. The first target information includes first information and/or second information, the first information at least includes fine-tuning configuration-related information of a first AI model, and the second information at least includes fine-tuning mode information of the first AI model.

In some embodiments, the first target information is sent by a second device, and the first AI model is any one of the following: a model preconfigured on the first device; a model preconfigured on the second device; a model trained by the second device; and a model relayed by the second device. The second device is a device that sends the first target information to the first device.

In some embodiments, the first target information further includes third information, and the third information at least includes information of the first AI model.

In some embodiments, the fine-tuning configuration-related information of the first AI model includes at least one of the following: a quantity of first layers, where the first layer is a layer that does not require parameter fine-tuning in the first AI model; a quantity of second layers, where the second layer is a layer that requires parameter fine-tuning in the first AI model; an index of the first layer; an index of the second layer; a fine-tuning data volume, where the fine-tuning data volume is a data volume required when the first AI model is fine-tuned; a target batch quantity, where the target batch quantity is a batch quantity of fine-tuning data required when the first AI model is fine-tuned; a batch size, where the batch size is a size of a data volume of each batch of fine-tuning data required when the first AI model is fine-tuned; a quantity of model iterations, where the quantity of model iterations is a total quantity of iterations required to achieve when the first AI model is fine-tuned for one time; target performance, where the target performance is model performance to be achieved when the first AI model is fine-tuned; a fine-tuning learning rate; and an adjustment strategy of fine-tuning rate.

In some embodiments, the fine-tuning mode information of the first AI model includes at least one of the following: a single fine-tuning mode; a cyclic fine-tuning mode; a fine-tuning cycle corresponding to the cyclic fine-tuning mode; an event-triggered fine-tuning mode; and trigger event information corresponding to the event-triggered fine-tuning mode.

In some embodiments, the apparatus 600 further includes: a second obtaining module, configured to receive a first request sent by the first device. The second sending module 610 is further configured to send the first information to the first device based on the first request.

In some embodiments, the second obtaining module is further configured to receive second target information sent by the first device. The second target information includes at least one of the following: first performance information, where the first performance information is model performance information of the first AI model; second performance information, where the second performance information is model performance information of a second AI model; first indication information, where the first indication information is used to indicate that the first device has completed fine-tuning the second AI model; and second indication information, where the second indication information is used to indicate that the first device has performed a model inference process based on the second AI model. The second AI model is a model obtained after model fine-tuning is performed on the first AI model for at least one time, or the second AI model is the first AI model that is in a model inference process or has completed at least one model inference process.

The model fine-tuning apparatuses 500 and 600 each in embodiments of this application may be a communication device, for example, a communication device having an operating system, or may be a component in a communication device, for example, an integrated circuit or a chip. The communication device may be a terminal or a network side device, or may be a device other than the terminal or the network side device. For example, the terminal may include, but is not limited to, the foregoing types of the terminal 11, and the network side device may include but is not limited to the foregoing types of the network side device 12. This is not specifically limited in embodiments of this application.

The model fine-tuning apparatuses 500 and 600 provided in embodiments of this application can implement the processes implemented in the method embodiments in FIG. 2 to FIG. 4, with the same technical effect achieved. To avoid repetition, details are not described herein again.

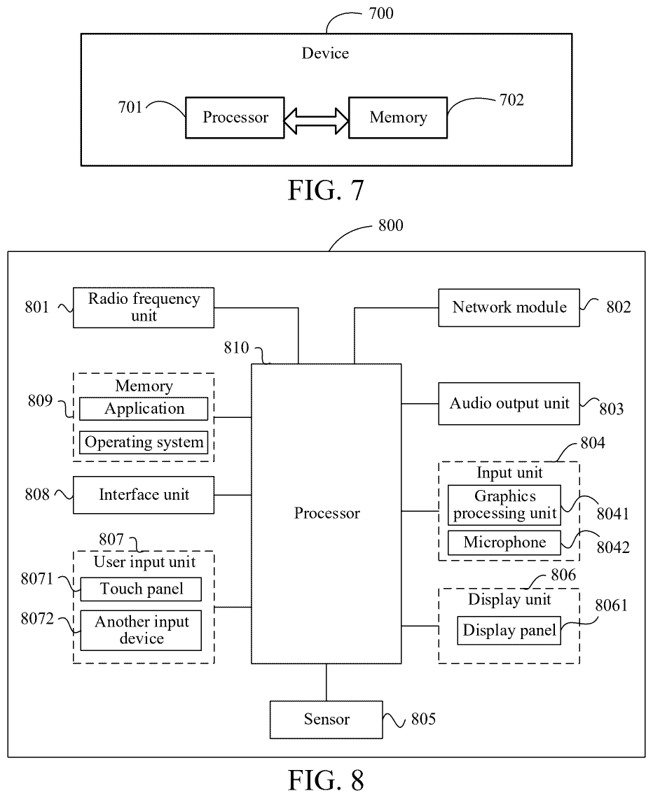

In some embodiments, as shown in FIG. 7, an embodiment of this application further provides a device 700, including a processor 701, a memory 702, and a program or an instruction that is stored in the memory 702 and capable of running on the processor 701. For example, when the device 700 is a terminal, and the program or instruction is executed by the processor 701, the steps of the model fine-tuning method embodiments 200 to 400 are implemented, with the same technical effect achieved. When the device 700 is a network side device, and the program or instruction is executed by the processor 701, the steps of the model fine-tuning method embodiments 200 to 400 are implemented, with the same technical effect achieved. To avoid repetition, details are not described herein again.

In an implementation, an embodiment of this application further provides a terminal, including a processor and a communication interface. The communication interface is coupled to the processor, and the processor is configured to run a program or an instruction to implement the steps of the method embodiments 200 to 400. This terminal embodiment corresponds to the foregoing method embodiment on the terminal side. Each implementation process and implementation of the foregoing method embodiment may be applicable to this terminal embodiment, with the same technical effect achieved. Specifically, FIG. 8 is a schematic diagram of a hardware structure of a terminal for implementing an embodiment of this application.

The terminal 800 includes, but is not limited to, at least a part of components such as a radio frequency unit 801, a network module 802, an audio output unit 803, an input unit 804, a sensor 805, a display unit 806, a user input unit 807, an interface unit 808, a memory 809, a processor 810, and the like.

A person skilled in the art can understand that the terminal 800 may further include a power supply (for example, a battery) that supplies power to the components. The power supply may be logically connected to the processor 810 through a power management system, so that functions such as charge and discharge management and power consumption management are implemented through the power management system. The structure of the terminal shown in FIG. 8 does not constitute any limitation on the terminal, and the terminal may include more or fewer components than shown in the diagram, or combine some of the components, or have different arrangements of the components. Details are not described herein again.

It should be understood that, in this embodiment of this application, the input unit 804 may include a Graphics Processing Unit (GPU) 8041 and a microphone 8042. The GPU 8041 processes image data of a static picture or a video obtained by an image capture apparatus (for example, a camera) in a video capture mode or image capture mode. The display unit 806 may include a display panel 8061, and the display panel 8061 may be configured in a form of a liquid crystal display, an organic light-emitting diode, or the like. The user input unit 807 includes at least one of a touch panel 8071 and another input device 8072. The touch panel 8071 is also referred to as a touchscreen. The touch panel 8071 may include two parts: a touch detection apparatus and a touch controller. The another input device 8072 may include, but is not limited to, a physical keyboard, a functional button (such as a volume control button or a power on/off button), a trackball, a mouse, a joystick, and the like. Details are not described herein again.

In this embodiment of this application, after receiving downlink data from a network side device, the radio frequency unit 801 may transmit the downlink data to the processor 810 for processing. In addition, the radio frequency unit 801 may transmit uplink data to the network side device. Generally, the radio frequency unit 801 includes, but is not limited to, an antenna, an amplifier, a transceiver, a coupler, a low noise amplifier, a duplexer, and the like.

The memory 809 is configured to store a software program or an instruction and various data. The memory 809 may mainly include a first storage area for program or instruction storage and a second storage area for data storage. The first storage area may store an operating system, an application or instruction required for at least one function (for example, a sound playing function and an image playing function), and the like. In addition, the memory 809 may be a volatile memory or a nonvolatile memory, or the memory 809 may include both a volatile memory and a nonvolatile memory. The nonvolatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDR SDRAM), an Enhanced SDRAM (ESDRAM), a Synch link DRAM (SLDRAM), and a Direct Rambus RAM (DR RAM). The memory 809 in this embodiment of this application includes, but is not limited to, these and any other suitable types of memories.

The processor 810 may include one or more processing units. In some embodiments, the processor 810 may integrate an application processor and a modem processor. The application processor mainly processes operations involving an operating system, a user interface, an application, and the like, and the modem processor mainly processes wireless communication signals, such as a baseband processor. It may be understood that, the modem processor may not be integrated into the processor 810.

In an implementation, the radio frequency unit 801 is configured to obtain first target information. The first target information includes first information and/or second information, the first information at least includes fine-tuning configuration-related information of a first AI model, and the second information at least includes fine-tuning mode information of the first AI model. The processor 810 is configured to fine-tune the first AI model based on the first information and/or the second information.

In another implementation, the radio frequency unit 801 is configured to send the first target information to a first device. The first target information includes first information and/or second information, the first information at least includes fine-tuning configuration-related information of a first AI model, and the second information at least includes fine-tuning mode information of the first AI model.

In this embodiment of this application, through migration of the first target information (for example, the first AI model, the fine-tuning configuration-related information of the first AI model, and the fine-tuning mode information of the first AI model), efficiency of training (or fine-tuning, verification, or the like) of the AI model on the first device is improved. This can avoid a problem of low AI model training efficiency, and ensure communication performance.

An embodiment of this application further provides a network side device, including a processor and a communication interface. The communication interface is coupled to the processor, and the processor is configured to run a program or an instruction to implement the steps of the methods of the embodiments 200 to 400. The network side device embodiment corresponds to the foregoing network side device method embodiment. Each implementation process and implementation of the foregoing method embodiment may be applicable to the network side device embodiment, with the same technical effect achieved.

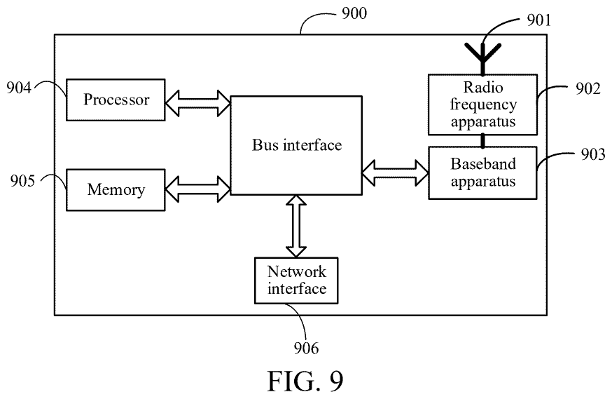

Specifically, an embodiment of this application further provides a network side device. As shown in FIG. 9, the network side device 900 includes: an antenna 901, a radio frequency apparatus 902, a baseband apparatus 903, a processor 904, and a memory 905. The antenna 901 is connected to the radio frequency apparatus 902. In an uplink direction, the radio frequency apparatus 902 receives information through the antenna 901, and sends the received information to the baseband apparatus 903 for processing. In a downlink direction, the baseband apparatus 903 processes to-be-sent information, and sends the information to the radio frequency apparatus 902; and the radio frequency apparatus 902 processes the received information and then sends the information out through the antenna 901.

The method performed by the network side device in the foregoing embodiments may be implemented in the baseband apparatus 903. The baseband apparatus 903 includes a baseband processor.

The baseband apparatus 903 may include, for example, at least one baseband board. A plurality of chips are disposed on the baseband board. As shown in FIG. 9, one chip is, for example, a baseband processor, and is connected to the memory 905 through a bus interface, to invoke a program in the memory 905, to perform network device operations shown in the foregoing method embodiments.

The network side device may further include a network interface 906. The interface is, for example, a Common Public Radio Interface (CPRI).

Specifically, the network side device 900 in this embodiment of the present disclosure further includes an instruction or a program that is stored in the memory 905 and capable of running on the processor 904. The processor 904 invokes the instruction or the program in the memory 905 to perform the method performed by the modules shown in FIG. 5 or FIG. 6, with the same technical effect achieved. To avoid repetition, details are not described herein again.

An embodiment of this application further provides a readable storage medium. The readable storage medium stores a program or an instruction. When the program or the instruction is executed by a processor, the processes of the foregoing method embodiments 200 to 400 are implemented, with the same technical effect achieved. To avoid repetition, details are not described herein again.

The processor is the processor in the terminal described in the foregoing embodiment. The readable storage medium includes a computer-readable storage medium, such as a computer read-only memory ROM, a random access memory RAM, a magnetic disk, an optical disc, or the like.

An embodiment of this application further provides a chip. The chip includes a processor and a communication interface, the communication interface is coupled to the processor, and the processor is configured to run a program or an instruction of a network side device, to implement the processes of the foregoing method embodiments 200 to 400, with the same technical effect achieved. To avoid repetition, details are not described herein again.

It should be understood that the chip in this embodiment of this application may also be referred to as a system-level chip, a system chip, a chip system, a system on chip, or the like.

An embodiment of this application further provides a computer program product. The computer program product includes a processor, a memory, and a program or an instruction that is stored in the memory and capable of running on the processor. When the program or the instruction is executed by the processor, the processes of the foregoing method embodiments 200 to 400 are implemented, with the same technical effect achieved. To avoid repetition, details are not described herein again.

An embodiment of this application further provides a model fine-tuning system, including: a first device and a second device. The first device may be configured to perform the steps of the foregoing method embodiment 200 and 300, and the second device may be configured to perform the steps of the foregoing method embodiment 400.

It should be noted that, in this specification, the term “include”, “contain”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. Without more limitations, elements defined by the sentence “including one” do not exclude that there are still other same elements in the process, method, article, or apparatus. In addition, it should be noted that the scope of the method and the apparatus in implementations of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In most circumstances, the former is an example implementation. Based on such an understanding, the technical solutions of this application essentially or the part contributing to the prior art may be implemented in a form of a computer software product. The computer software product is stored in a storage medium (such as a ROM/RAM, a hard disk, or an optical disc), and includes several instructions for instructing a terminal (which may be a mobile phone, a computer, a server, an air-conditioner, a network device, or the like) to perform the method described in embodiments of this application.

Embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms without departing from the purpose of this application and the protection scope of the claims, all of which fall within the protection of this application.

What is claimed is:

1. A model fine-tuning method, comprising:
obtaining, by a first device, first target information, wherein the first target information comprises first information or second information, the first information at least comprises fine-tuning configuration-related information of a first Artificial Intelligence (AI) model, and the second information at least comprises fine-tuning mode information of the first AI model; and
fine-tuning, by the first device, the first AI model based on the first information or the second information.

2. The method according to claim 1, wherein the first AI model is any one of the following:
a model preconfigured on the first device;
a model preconfigured on a second device;
a model trained by the second device; or
a model relayed by the second device,
wherein the second device is a device that sends the first target information to the first device.

3. The method according to claim 1, wherein the target information further comprises third information, and the third information at least comprises information of the first AI model.

4. The method according to claim 1, wherein the fine-tuning configuration-related information of the first AI model comprises at least one of the following:
a quantity of first layers, wherein the first layer is a layer that does not require parameter fine-tuning in the first AI model;
a quantity of second layers, wherein the second layer is a layer that requires parameter fine-tuning in the first AI model;
an index of the first layer;
an index of the second layer;
a fine-tuning data volume, wherein the fine-tuning data volume is a data volume required when the first AI model is fine-tuned;
a target batch quantity, wherein the target batch quantity is a batch quantity of fine-tuning data required when the first AI model is fine-tuned;
a batch size, wherein the batch size is a size of a data volume of each batch of the fine-tuning data required when the first AI model is fine-tuned;
a quantity of model iterations, wherein the quantity of model iterations is a total quantity of iterations required to achieve when the first AI model is fine-tuned for one time;
target performance, wherein the target performance is model performance to be achieved when the first AI model is fine-tuned;
a fine-tuning learning rate; or
an adjustment strategy of fine-tuning rate.

5. The method according to claim 1, wherein the fine-tuning mode information of the first AI model comprises at least one of the following:
a single fine-tuning mode;
a cyclic fine-tuning mode;
a fine-tuning cycle corresponding to the cyclic fine-tuning mode;
an event-triggered fine-tuning mode; or
trigger event information corresponding to the event-triggered fine-tuning mode.

6. The method according to claim 1, further comprising:
running, by the first device, the first AI model based on a first dataset, to obtain first performance information; and
when it is determined, based on the first performance information, that the first AI model needs to be fine-tuned, performing, by the first device, a step of fine-tuning the first AI model based on the first information or the second information.

7. The method according to claim 6, further comprising:
when it is determined, based on the first performance information, that the first AI model does not need to be fine-tuned, performing, by the first device, a model inference process based on the first AI model.

8. The method according to claim 6, wherein to determine, based on the first performance information, that the first AI model needs to be fine-tuned, the method further comprises:
when the first performance information meets a first condition, determining that the first AI model needs to be fine-tuned,
the first condition comprises at least one of the following:
the first performance information is greater than or equal to a first threshold;
the first performance information is less than or equal to a second threshold;
within a first time period, a quantity of times that the first performance information is greater than or equal to the first threshold reaches a third threshold;
within a second time period, a quantity of times that the first performance information is less than or equal to the second threshold reaches a fourth threshold;
a duration during which the first performance information is greater than or equal to the first threshold reaches a fifth threshold; or
a duration during which the first performance information is less than or equal to the second threshold reaches a sixth threshold.

9. The method according to claim 1, wherein before performing the step of fine-tuning the first AI model based on the first information or the second information, the method further comprises:
when the first target information does not comprise the first information, sending, by the first device, a first request to the second device, wherein the first request is used to request the first information from the second device; and
receiving, by the first device, the first information sent by the second device.

10. The method according to claim 2, further comprising:
when model performance information of a second AI model meets a second condition, fine-tuning, by the first device, the second AI model based on at least one of a third dataset, the first information, or the second information,
wherein the second condition is determined based on at least one piece of information other than the single fine-tuning mode in the fine-tuning mode information of the first AI model, and the second AI model is a model obtained after model fine-tuning is performed on the first AI model for at least one time, or the second AI model is the first AI model that is in a model inference process or has completed at least one model inference process.

11. The method according to claim 6, further comprising:
sending, by the first device, second target information to the second device or a third device,
wherein the second device is a device that sends the first target information to the first device, the third device is a monitoring or maintenance device of the first AI model, and the second target information comprises at least one of the following:
the first performance information, wherein the first performance information is model performance information of the first AI model;
second performance information, wherein the second performance information is the model performance information of the second AI model;
first indication information, wherein the first indication information is used to indicate that the first device has completed fine-tuning the second AI model; or
second indication information, wherein the second indication information is used to indicate that the first device has performed a model inference process based on the second AI model,
wherein the second AI model is a model obtained after model fine-tuning is performed on the first AI model for at least one time, or the second AI model is the first AI model that is in a model inference process or has completed at least one model inference process.

12. A model fine-tuning method, comprising:
sending, by a second device, first target information to a first device,
wherein the first target information comprises first information or second information, the first information at least comprises fine-tuning configuration-related information of a first AI model, and the second information at least comprises fine-tuning mode information of the first AI model.

13. The method according to claim 12, wherein the first AI model is any one of the following:
a model preconfigured on the second device;
a model preconfigured on the first device;
a model trained by the second device; or
a model relayed by the second device.

14. The method according to claim 12, wherein the first target information further comprises third information, and the third information at least comprises information of the first AI model.

15. The method according to claim 12, wherein the fine-tuning configuration-related information of the first AI model comprises at least one of the following:
a quantity of first layers, wherein the first layer is a layer that does not require parameter fine-tuning in the first AI model;
a quantity of second layers, wherein the second layer is a layer that requires parameter fine-tuning in the first AI model;
an index of the first layer;
an index of the second layer;
a fine-tuning data volume, wherein the fine-tuning data volume is a data volume required when the first AI model is fine-tuned;
a target batch quantity, wherein the target batch quantity is a batch quantity of fine-tuning data required when the first AI model is fine-tuned;
a batch size, wherein the batch size is a size of a data volume of each batch of fine-tuning data required when the first AI model is fine-tuned;
a quantity of model iterations, wherein the quantity of model iterations is a total quantity of iterations required to achieve when the first AI model is fine-tuned for one time;
target performance, wherein the target performance is model performance to be achieved when the first AI model is fine-tuned;
a fine-tuning learning rate; or
an adjustment strategy of fine-tuning rate.

16. The method according to claim 12, wherein the fine-tuning mode information of the first AI model comprises at least one of the following:
a single fine-tuning mode;
a cyclic fine-tuning mode;
a fine-tuning cycle corresponding to the cyclic fine-tuning mode;
an event-triggered fine-tuning mode; or
trigger event information corresponding to the event-triggered fine-tuning mode.

17. The method according to claim 12, further comprising:
receiving, by the second device, a first request sent by the first device; and
sending, by the second device, the first information to the first device based on the first request.

18. The method according to claim 12, further comprising:
receiving, by the second device, second target information sent by the first device,
wherein the second target information comprises at least one of the following:
first performance information, wherein the first performance information is model performance information of the first AI model;
second performance information, wherein the second performance information is model performance information of the second AI model;
first indication information, wherein the first indication information is used to indicate that the first device has completed fine-tuning the second AI model; or
second indication information, wherein the second indication information is used to indicate that the first device has performed a model inference process based on the second AI model,
wherein the second AI model is a model obtained after model fine-tuning is performed on the first AI model for at least one time, or the second AI model is the first AI model that is in a model inference process or has completed at least one model inference process.

19. A device, comprising: a processor and a memory storing instructions, wherein the instructions, when executed by the processor, cause the processor to perform operations comprising:
obtaining first target information, wherein the first target information comprises first information or second information, the first information at least comprises fine-tuning configuration-related information of a first Artificial Intelligence (AI) model, and the second information at least comprises fine-tuning mode information of the first AI model; and
fine-tuning the first AI model based on the first information or the second information.

20. A device, comprising: a processor and a memory storing instructions, wherein the instructions, when executed by the processor, cause the processor to perform the method according to claim 12.
